(19) United States
(12) Patent Application Publication
(10) Pub. No.: US 2005/0183327 A1
(43) Pub. Date: Aug. 25, 2005

(54) Greenhouse system and method

(76) Inventors: Allen J. Williford, Brandon, FL (US); Lynda Kay Williford, Brandon, FL (US)

Correspondence Address: FOLEY AND LARDNER;SUITE 500, 3000 K STREET NW, WASHINGTON, DC, 20007, US

(21) Appl. No.: 10/785,047

(22) Filed: Feb. 25, 2004

(51) Int. Cl. A01G 9/14

(52) U.S. Cl. 47/17

(57) ABSTRACT

A method and system for a greenhouse includes a plant box for planting plants and seedlings, a structure for providing a water flow system proximate to the plant box. A water distribution system distributes water to the water flow system, and a system heats or cools the water distributed by the water distribution system to control the soil temperature in the plant box.

### BACKGROUND OF THE INVENTION

In existing or traditional greenhouses, it is very difficult to grow plants and fruits that require specific soil and temperature conditions at different times to ensure optimal production. These traditional greenhouse structures often consist of transparent glass or poly panes forming a roof and structure to enclose a growing area and have a heater to provide heat in the cooler months. Therefore, one of the solutions for growing fruits, such as strawberries, has been to transplant the strawberries from one environment to another when a different environment is required for a different stage of its growth and fruiting cycle.

Likewise, in existing greenhouses, another problem pertains to growing different plants and fruits in the same greenhouse since each of the different plants and fruits often require different soil, moisture, and temperature conditions which are very difficult to provide in one greenhouse.

Therefore, some of the known solutions to improve greenhouse productivity have included efforts to heat the air or the soil in order to provide warmer growing or fruiting environments. However, these solutions do not provide the optimal control of the greenhouse environments that is often required for producing fruits, like strawberries, that require relatively specific temperatures during its growing and fruiting cycle.

### SUMMARY OF THE INVENTION

Certain embodiments of the present invention provide a greenhouse system including: a plant box for planting plants and seedlings, a structure for embedding a water flow system proximate to the plant box; a water distribution system for distributing water to the water flow system; and a system for heating or cooling water distributed by the water distribution system.

Certain embodiments further include an added shade system arranged outside the greenhouse to cool air entering the greenhouse.

Some embodiments include a structure for attaching the plant box to an overhead structure of the greenhouse.

Some embodiments further include a gutter system for collecting drainage from the plant box.

In certain embodiments, the water flow system includes tubes and the structure for embedding the water flow system includes grooves in the plant box on which the tubes are arranged.

In certain embodiments of the present invention, the system for heating or cooling water includes a reversible heat pump.

In certain embodiments of the present invention, the structure for attaching the plant box includes steel cables, and wherein a motor and gearbox combination raises and lowers the steel cables to thereby raise and lower the plant box.

In certain embodiments, the present invention provides a method of growing plants and seedlings in a greenhouse, including: providing a plant box for planting plants and seedlings, providing a water flow system proximate to the plant box; distributing water to the water flow system proximate to the plant box; and heating or cooling the water in the water flow system to control a soil temperature in the plant box.

In certain embodiments, the present invention provides a plant box for a greenhouse including: a bottom surface and a side wall structure; and at least one groove in the bottom surface designed for arranging a water flow tube therein.

In certain embodiments, the plant box includes at least one drain hole in the bottom surface for providing drainage from the plant box to a gutter system.

In certain embodiments, the present invention includes plants and strawberries grown using the methods of the present invention.

### BRIEF DESCRIPTION OF THE DRAWINGS

The accompanying drawings, which are incorporated in and constitute a part of the specification, illustrate embodiment(s) of the invention, and, together with the general description given above and the detailed description of the embodiment(s) given below, serve to explain the principles of the invention.

FIG. 1 is a side view and FIG. 2 is an end view of the greenhouse system showing a structure that can support the growing system from the overhead structure of the greenhouse.

FIG. 3 is a cross-sectional view of a gutter.

FIG. 4 is a cross-sectional view of a plant box.

FIG. 5 is an end view of the greenhouse showing an additional shaded portion.

FIG. 6 is an end view of the greenhouse showing one embodiment of the water distribution system.

### DETAILED DESCRIPTION OF THE EMBODIMENTS

Certain embodiments of the present invention are described below with reference to drawings. These drawings illustrate certain details of specific embodiments of the systems, methods, and programs of these embodiments. However, describing embodiments of the invention with drawings should not be construed as imposing on the invention any limitations that may be present in the drawings.

Some of the features in certain embodiments of the present invention include the following features listed below and discussed in greater detail further herein with respect to the figures.

1. A well ventilated greenhouse with an added shade system provided outside the greenhouse to cool the air naturally before it enters the greenhouse.

2. A system for supporting the growing system from an overhead structure of the greenhouse. The system can be raised or lowered so that the optimal use is made of the space within the greenhouse while the plants or crop can be easily accessed when needed.

3. A system including a gutter or trough to support the growing plant boxes and allow the collection of drain water from the crop.

4. An insulated plant box for planting which provides drainage to the gutter for draining excess irrigation water and includes grooves, for example, in the bottom for placing tubes which carry the water for heating and cooling the soil as needed. The plant box may be lined with a film, such as a plastic film, before being filled with the growing media. The film may have slits or holes to enable drainage from the box to the gutter system. Alternatively, a plastic film tube or other sealed container that is pre-filled with the growing media may be used instead since it may allow for easy removal of the material once the crop is finished.

Based on these features, a greenhouse may be used by one skilled in the art to grow crops that require specific soil and temperature conditions at different stages of its growth cycle. Therefore, one skilled in the art would recognize that such a system could be used for growing strawberries by propagating and conditioning their own strawberry plants at the same location without the need for removal of the plants to a different location for the purposes of conditioning the plants climatically for inducing a fruiting response. Strawberry plants require a certain amount of “chilling” in order for them to provide the fruiting response and bear fruit. If this chilling is not timely provided, the fruit cycle is delayed until it occurs naturally. Currently, strawberry nursery plants are grown in a northern climate where it begins to cool down in the late summer months and therefore, the plants have to be dug and shipped long distance to the southern climates for planting.

Therefore, certain embodiments of the present invention provide for starting with a clean, virus-indexed root stock “mother” plants purchased, for example, from a reliable nursery. These plants would then be planted in small containers (for example 6″ pots), and grown to make runners, which are also known as daughter plants. In one embodiment, the mother plant is placed on top of the plant box in the greenhouse. As the mother plants starts to produce daughter plants, each daughter plant is pinned to the growing media or the plastic film tube at the proper spacing in the plant box or boxes. Once these daughter plants are of sufficient size and/or all the daughter plants needed have been generated, the daughter plants are cut loose from the mother plants and the mother plants are discarded.

Thereafter, once the daughter plants are well established and are several weeks old, the fertility of the soil is reduced and the soil temperature is reduced by suitable use of a reverse cycle heat pump or other similar means to chill the water that circulates in the tubes in the plant box. These tubes in the plant boxes constitute a water flow system which allows the flow of water that can be heated or cooled so that the soil temperature could be actively controlled. The purpose of reducing the soil temperature is to prevent the runners (or daughter plants) from growing further and provide the chilling that induces the fruiting response.

For example, this chilling could be provided in the mid to late summer when the soil temperature would need to be lower than 50° F. to achieve the desired fruiting response. Of course, the exact temperature would vary with the type of fruit and the different varieties of each type of fruit as would be recognized by those skilled in the art. Thereafter, once the plants have received the desired amount of climatic conditioning, the soil temperature is gradually raised again to about 75° F. to 85° F. (for example, by suitably running warm water through the water flow system) since this is the preferred temperature needed to promote good growth and fruiting response. The short days of the winter months will prevent the plant from running again until at least late spring or early summer. Therefore, by using the same water flow system for both cooling and heating the root systems of the plants, the importance of the ambient air temperature is greatly reduced as long as it is kept above a certain temperature, for example, the freezing point. In fact, a superior quality of fruit is produced by only heating the soil rather than heating the air. Furthermore, such a system saves a lot of time and labor by concentrating the growth of a large number of plants at one location (without the need for transplanting, for example). In addition, by creating the micro-climate for the root system of each plant, the need for heating or cooling the entire space of the greenhouse is greatly reduced. Furthermore, since the microclimate for each plant box (or a proximate group of plant boxes) can be separately controlled, it is much easier to grow a wide variety of different plants and fruits even if they require different optimal soil conditions from each other.

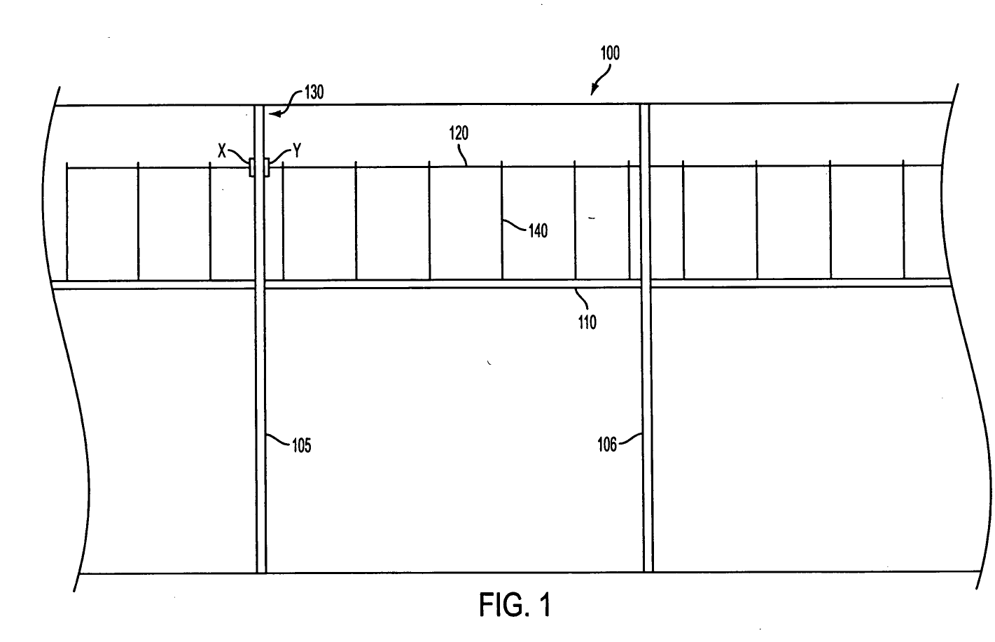

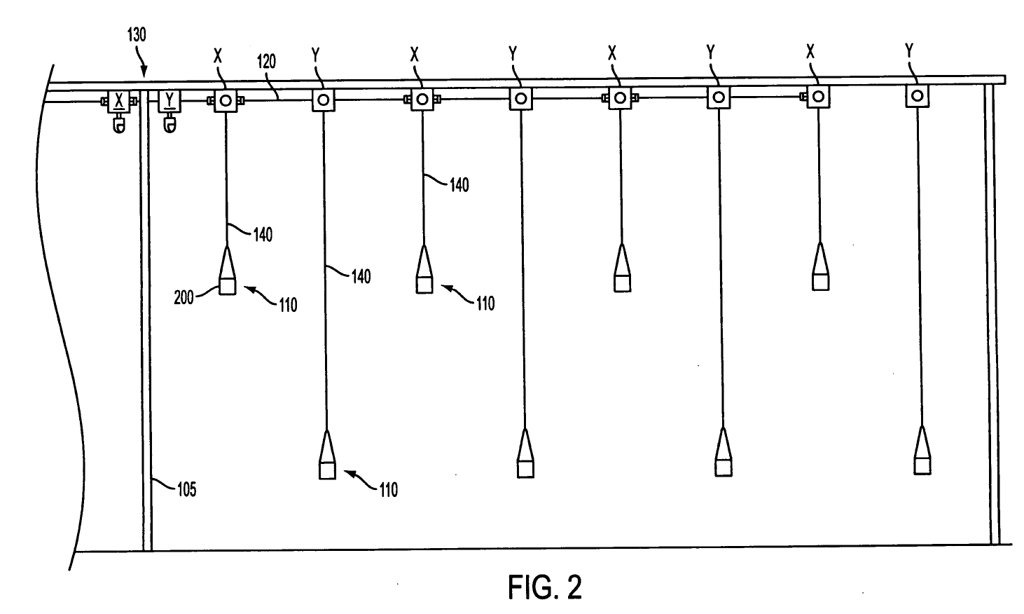

Referring to the figures, FIGS. 1-4 disclose one embodiment of the improved greenhouse system according to the present invention. FIG. 1 is a side view and FIG. 2 is an end view of the greenhouse system 100 showing the structure that can support the growing system from the overhead structure of the greenhouse. The overhead structure of the greenhouse system 100 includes an overhead support pipe or structure 120 from which other components of the greenhouse system 100 is suspended. The overhead support pipe or structure 120 may be supported either directly or indirectly by greenhouse support columns 105, 106 which are supported by the greenhouse floor. The overhead support pipe 120 supports cables 140 (for example, stainless steel cables) that support a gutter system and plant boxes in which the crop are grown. A suitable gearbox system 130 is provided by which the cables 140 can be raised and lowered and thereby a gutter 110 which is connected to the ends of the cables 140 can also be raised or lowered. As shown in FIG. 2, the gear box system 130 can be arranged so that there is a master gearbox that supports other secondary gearboxes. The plant boxes are supported on the gutters 110 and therefore, the plant boxes can be stored on the gutters above the ground or floor level. The gutters and the plant boxes thereon can be lowered to the ground or floor level when access to the plant box or the gutter is required for cultivation or maintenance purposes.

As shown in FIG. 2, the each row of the plant boxes 200 arranged on a gutter can be arranged such that adjacent rows of plant boxes on respective gutters are raised or lowered by a separate gear box controlled system. That is, all the rows of plant boxes (and their corresponding gutters 110) marked “X” in FIG. 2 may be raised or lowered as a group while the rows of plant boxes (and their corresponding gutters) marked “Y” in FIG. 2 may also be raised or lowered as a group. This arrangement allows the plants to be spaced closer together so that an optimal usage of the greenhouse 100 floor area is achieved. For example, adjacent rows (one X row and its adjacent Y row) may be spaced 45 cm apart which does not allow sufficient room between the rows to perform the necessary work for raising a crop. However, by raising one set of rows of plant boxes (for example, the rows marked X) while lowering the other set of rows of plant boxes (for example, the rows marked Y), enough space is provided for working the plant boxes in the rows marked Y. Subsequently, by raising the Y rows and lowering the X rows, enough space is provided for working on the plant boxes in the X rows. Furthermore, when finished working on the particular rows of plant boxes, the particular rows of the plant boxes may be kept at a height that ensures optimal light and other conditions for each of the rows. Furthermore, some of the rows may also be lowered to the floor level so that a crop that needs to be trellised can be grown.

The gear system 130 typically includes one or more gearboxes and a drive source such as a motor so that the cables 140 can be moved upward, downward, or laterally so that the gutter 110 connected to the cables can also be correspondingly moved. Furthermore, as would be recognized by those skilled in the art, the drive and gear system 130 could be configured so that a certain number of cables 140 are raised or lower synchronously so that a gutter 110 that is connected to that certain number of cables 140 is raised and lowered synchronously. Design of a suitable drive and gear system in accordance with the teachings of the present invention is within the abilities of one skilled in the art considering the teachings herein.

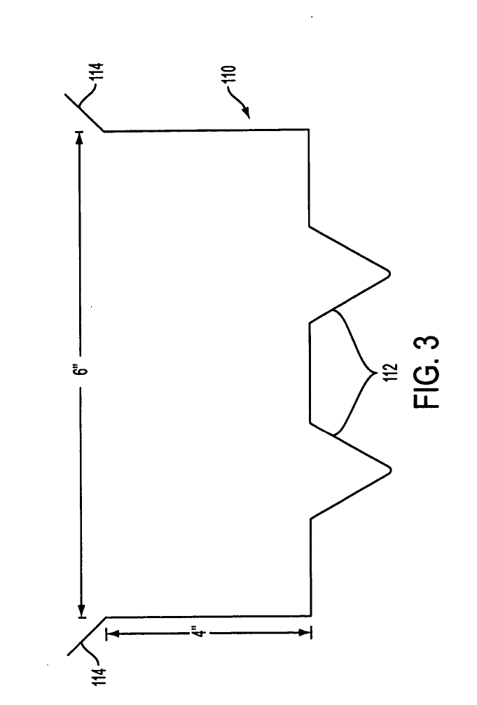

FIG. 3 is a cross-sectional view of a gutter 110 according to one embodiment of the present invention. It should be noted that the dimensions shown in FIG. 3 are exemplary only and should not be construed to limit the claimed invention in any way. The gutter 110 is formed with sufficient strength so that it can support the requisite number of plant boxes including the growing media and plants contained in the plant boxes. The actual number of plant boxes contained within a gutter will vary on a number of factors including the dimensions of the greenhouse and the size and spacing requirements of the crops grown in the plant boxes contained in the gutters. In certain embodiments, the gutter 110 forms a gutter channel that provides support for plant boxes that can be placed in the gutter channel while the gutter channel also functions as a drainage channel to drain excess moisture or fluids away from the plant boxes to a drainage system. In certain embodiments, the gutter 110 contains a flare 114 or other attachment structure (such as a hook) by which the cables 140 from the overhead structure 120 can be attached to the gutter 110. Therefore, the gutter 110 can be raised or lowered by upward, downward, or lateral movement of the cables 140 by a motor and gear system 130.

The gutter 110 may be formed by roll forming steel or other similar material of suitable strength and adding a non-corrosive coating so that it is not corroded by the water that is drained by the gutter 110. In one embodiment, the bottom or lower surface of the gutter 110 may be formed with one or more V shaped indentations 112 which provide additional strength and act as channels for carrying the drainage water.

In one embodiment, pipes carrying the water to heat the soil in the plant boxes may be placed in the gutters 110. Since the plant box 200 is placed on the gutter, these pipes arranged on the gutter 110 are in sufficient proximity to the soil in the plant boxes 200 so that they can serve to heat of cool the soil in the plant box 200. For example, in one embodiment, the water carrying pipes may be embedded in the V shaped notches 112 on the bottom surface of the gutters 110. Alternatively, the water carrying pipes may even be arranged below the gutter by using suitable clamps or fasteners to attach the pipes to the underside of the gutter. One of skill in the art would also recognize that water is disclosed herein as a fluid for exchanging heat with the soil in the plant boxes. As would be recognized by those skilled in the art, the present invention also contemplates the use of other such fluids that serve the function of exchanging heat with the soil in the plant boxes 200. For example, if only heating is desired, steam could be provided through the pipes to heat the soil while a cooling function could be provided by circulating a suitable coolant through the pipes.

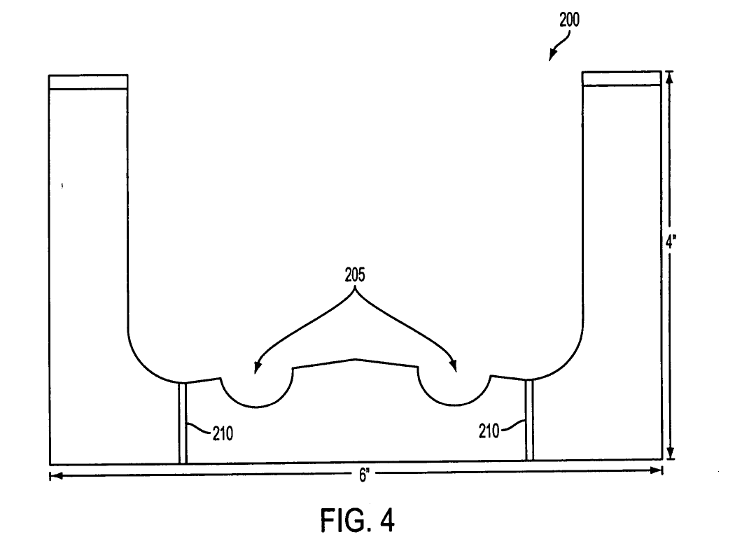

FIG. 4 is a cross-sectional view of one embodiment of a plant box 200 that may be placed in the gutter 110, as described earlier herein. It should be noted that the dimensions shown in FIG. 4 are exemplary only and should not be construed to limit the claimed invention in any way. The plant box 200 includes an opening on an upper surface of the plant box so that the growing media can be placed in the plant box and the plant can grow in the plant box.

The plant box includes a one or more grooves 205 in a lower surface of the plant box so that one or more tubes can be placed in the plant box. Of course, additional grooves may be provided, for example, on the sides of the plant box 200, so that a sufficient number of tubes (not shown) can be provided that is proximate to the growing media (or soil) that is placed in the plant box 200 for supporting the root growth of the plant grown in the plant box. The tubes arranged in the grooves 205 can be made of PVC or any other lightweight material that would be known to those skilled in the art based on the teachings herein. The tubes are used to circulate water of other fluids so that the temperature of the water of other fluid can be used to control the soil temperature of the plant box 200. That is, the tubes in one or more of the plant boxes may be connected, either individually or in groups, to a water source to form a water flow system. It should be recognized that in most greenhouses, all the plant boxes would be maintained at a same soil temperature to most efficiently grow the crops in the plant boxes. However, if the greenhouses are large enough, the present invention also contemplates that groups of plant boxes could be maintained at different soil temperatures with the use of the suitable partitions between the groups of plant boxes to make the temperature difference more efficient from the standpoint of energy efficiency of the greenhouse.

The water flow system is connected to a water distribution system that includes a heating and cooling system so that the water temperature in the tubes can be controlled (by heating or cooling) such that the soil temperature in the plant box 200 can be actively controlled. In one embodiment, a reversible heat pump may be connected to the water distribution system so that it can be used to either heat or cool the water in the water flow system based on the soil temperature that is desired. In this manner, the water flow system connected to a heating and cooling system provides a mechanism by which the soil temperature of the plant box 200 can be actively controlled.

In one embodiment, such a water distribution system may include either a reversible heat pump (if the ability to both heat and cool is desired), a boiler or heater (if only heating is desired), or an air conditioning or other cooling unit (if only cooling is desired) that is arranged outside the greenhouse. A water flow main supply pipe carries the heated or cooled water into the greenhouse for circulation through the water flow system that serves to heat or cool the soil in the plant boxes 200. A return flow pipe typically returns the water after it has circulated through the water flow system so that it can be heated or cooled, as required, and then re-circulated through the greenhouse. The main water pipe from the outside may arranged to traverse the rows of plant boxes in a direction perpendicular to the rows with flexible tubing leading from the main water pipe to a rows of plant boxes. The other end of the flexible tubing would then be connected to the return flow pipe.

The heated or cooled water from the heat pump, for example, is typically mixed with other water that has not been heated or cooled by using a mixing valve that is typically computer controlled using commercially available feedback controlled computer system that adjusts the mixture of the heated or cooled water with the other water so that a desired temperature is achieved. Soil temperature sensors can be provided in the soil which provide a feedback to the computer controlled system so that a desired soil temperature can be maintained by adjusting the temperature of the water circulating through the water flow system in the greenhouse in response the soil temperature detected by the soil temperature sensors. Details of such a computer controlled system for maintaining a desired soil temperature is well within the abilities of one skilled in the art by using commercially available equipment.

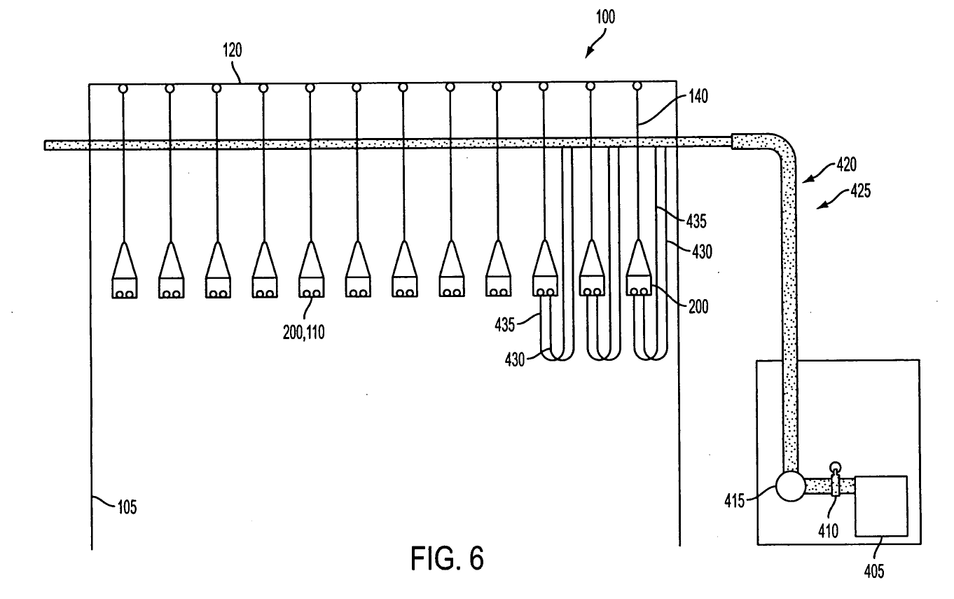

FIG. 6 discloses one example of a water distribution system that can be used to provide the temperature controlled water flow system that is arranged proximate to the plant boxes. A heating or cooling source 405, such as a boiler or heat pump, is connected to a supply pipe 420 through a mixing valve 410 and a circulation pump 415. The mixing valve 410 is typically feedback controlled (for example, based on soil temperature data) so that water flowing to the circulation pump 415 is at a desired or set temperature. The circulation pump 415 pumps the water through a supply pipe 420 that runs through the greenhouse 100 and provides the temperature controlled water to each of the rows of plant boxes 200. For each row of plant boxes, a flexible supply tube 430 extends from the supply pipe 420 and connects to the water flow system that flows proximate to all the plant boxes 200 that are arranged on one row of plant boxes 200. After the water has flowed through all the plant boxes in one row of plant boxes 200, a flexible return tube 435 returns the water to a return pipe 425 that also runs through the greenhouse 100. The return pipe 435 returns the water to the heating or cooling source 405 so that the returned water can be recirculated after being heated or cooled to the desired or set temperature.

The plant box 200 also includes one or more drainage holes 210 by which drainage from the plant box 200 can flow into the gutter 110 on which the plant box 200 is arranged. Typically, multiple plant boxes 200 will be laid on a gutter in an end-to-end fashion. In certain embodiments, the plant boxes 200 may be made from Styrofoam or other similar lightweight materials.

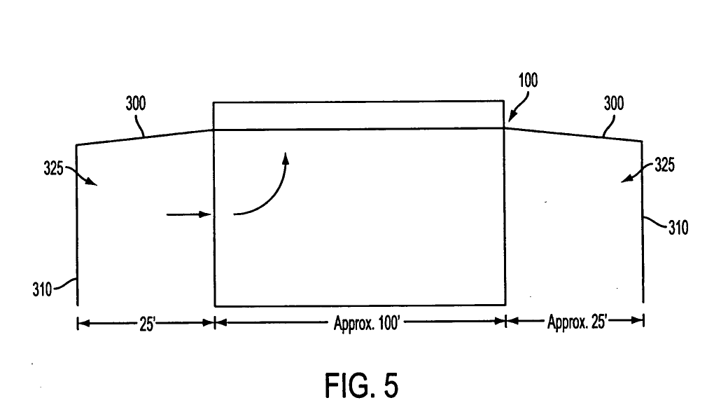

FIG. 5 is an end view of the greenhouse showing an additional shaded portion to naturally cool the air entering the greenhouse. The dimensions shown in FIG. 5 are exemplary only and should not be construed to limit the claimed invention in any way. The greenhouse 100 is provided with a shade 300 on each side from which air enters the greenhouse (for example, through greenhouse walls that have been designed with vents) so that air entering the greenhouse is naturally cooled rather than being heated by air flowing from an area heated by sunlight. The shades 300 are supported by poles or supports 310 so that there is sufficient room for air from outside to flow into the greenhouse 100 after being naturally cooled by the shaded area 325 under the shades 300. The shades 300 may be made from 90% or better shade cloth.

In addition to the great flexibility in planting crops provided by the temperature control of the soil of the plant boxes, the present invention also provides significant thermal efficiencies for the greenhouse. By heating the soil of the plant boxes, the need for controlling the ambient air temperature of the greenhouse is greatly reduced and this results in significantly increasing the thermal efficiency of the greenhouse since the energy required to control the considerable air volume of the greenhouse is significant. In fact, in many circumstances, the heat radiated from the soil may be sufficient to adequately heat the greenhouse and since the greenhouse may only need to heated to a lower temperature the overall efficiency of the greenhouse may be improved.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

1. A greenhouse system comprising:
a plant box for planting plants and seedlings;
a structure for embedding a water flow system proximate to the plant box;
a water distribution system for distributing water to the water flow system; and
a system for heating or cooling water distributed by the water distribution system.

2. The greenhouse system according to claim 1, further comprising an added shade system arranged outside the greenhouse to cool air entering the greenhouse.

3. The greenhouse system according to claim 2, further comprising a structure for attaching the plant box to an overhead structure of the greenhouse.

4. The greenhouse system according to claim 3, further comprising a gutter system for collecting drainage from the plant box.

5. The greenhouse system according to claim 1, wherein the water flow system comprises tubes.

6. The greenhouse system according to claim 1, wherein the tubes are made of plastic.

7. The greenhouse system according to claim 5, wherein the structure for embedding the water flow system comprises grooves in the plant box on which the tubes are arranged.

8. The greenhouse system according to claim 1, wherein the system for heating or cooling water comprises a reversible heat pump that can heat or cool the water.

9. The greenhouse system according to claim 1, wherein the system for heating or cooling water comprises a boiler that can heat the water.

10. The greenhouse system according to claim 3, wherein the structure for attaching the plant box comprises steel cables that attach to a gutter on which the plant box is arranged, and wherein a motor and gearbox unit raises and lowers the steel cables to thereby raise and lower the gutter and the plant box.

11. The greenhouse system according to claim 4, wherein the gutter system includes a gutter channel for supporting the plant box and wherein a lower surface of the gutter channel comprises a V shaped section.

12. The greenhouse system according to claim 1, wherein the structure for providing the water flow system comprises tubes arranged between the plant box and the gutter.

13. The greenhouse system according to claim 10, wherein the motor and gearbox unit comprises two motor and gearbox units with a first motor and gearbox unit connected to one set of first plant boxes and a second motor and gearbox unit connected to another set of second plant boxes, wherein the first plant boxes are arranged alternately with the second plant boxes in a row plant boxes.

14. A method of growing plants and seedlings in a greenhouse, comprising:
providing a plant box for planting plants and seedlings;
providing a water flow system proximate to the plant box;
distributing water to the water flow system proximate to the plant box; and
heating or cooling the water in the water flow system to control a soil temperature in the plant box.

15. The method according to claim 14, further comprising:
attaching the plant box to an overhead structure of the greenhouse; and
raising or lowering the plant box to access or work on the plant box.

16. The method according to claim 14, further comprising providing a gutter system for collecting drainage from the plant box.

17. The method according to claim 14, further comprising providing grooves in the plant box, and
arranging tubes in the plant box, wherein the tubes are part of the water flow system.

18. The method according to claim 17, further comprising heating or cooling the water in the water flow system in order to provide a desired soil temperature in the plant box.

19. A plant box for a greenhouse comprising:
a bottom surface and a side wall structure; and
at least one groove in the bottom surface designed for arranging a water flow tube therein.

20. The plant box according to claim 19, further comprising at least one drain hole in the bottom surface for providing drainage from the plant box to a gutter system.

21. A plant grown using the method according to claim 14.

22. The plant according to claim 21, wherein the plant comprises a strawberry plant.
